(19) United States
(12) Patent Application Publication
(10) Pub. No.: US 2015/0270028 A1
(43) Pub. Date: Sep. 24, 2015

(54) USB CABLE

(71) Applicant: HON HAI PRECISION INDUSTRY CO., LTD., New Taipei (TW)

(72) Inventors: PEI TSAO, Pomona, CA (US); LU-YU CHANG, New Taipei (TW); HONG-PING WANG, Kunshan (CN); HONG-MING ZHAO, Kunshan (CN)

(73) Assignee: HON HAI PRECISION INDUSTRY CO., LTD., New Taipei (TW)

(21) Appl. No.: 14/222,905

(22) Filed: Mar. 24, 2014

(51) Int. Cl. H01B 7/18

(52) U.S. Cl. CPC H01B 7/18

(57) ABSTRACT

A USB cable (100), comprising: a power wire (1) transferring positive power, a pair of signal wires (2), a metallic braided layer (5) enclosing on the power wire and the signal wires, an insulative outer jacket (6) surrounding the metallic braided layer, and three drain wires disposed in the metallic braided layer. The power wire comprises a metallic inner conductor and an insulative layer surrounding the inner conductor, and the insulative layer of the power wire is made of Polypropylene. The three drain wires comprises a pair of first drain wires (31) and a second drain wire (32), and each first drain wire has a larger external dimension than the second drain wire.

### FIELD OF THE INVENTION

The present invention relates to a cable, and more particularly to a USB (universal serial bus) cable.

### DESCRIPTION OF PRIOR ART

Universal Serial Bus, or “USB” is a commonly used term that refers to a standard for connecting two electronic devices or for connecting a device and a host computer. Using USB technology, a plurality of peripherals can be connected using a single standardized interface socket. As of 2006, the USB specification was at version 2.0 (with revisions). The USB 2.0 specification was released in April 2000 and was standardized by the USB-IF at the end of 2001.

According to USB 2.0 specification, a USB cable has four inner wires, including a pair of signal wires transferring D−, D+ signal, the other two wires being power wires. The USB cable is used widely with a function of charging. The power wire of USB cable is required to transfer larger electric current used for peripheral equipments demanding high power, thus the inner wires may have larger external dimensions, though characteristics of small dimension and flexibility of USB cables are determined by specific needs. For meeting a smaller overall dimension while a larger current-carrying conductor, the wire might have a thinner insulating layer, raising concern for safety issue. U.S. Patent Application Publication No. 2012/0227996, to Ardisana, II et al. on Sep. 13, 2012, discloses a cable that can be used as a USB cable, including a conductor bundle, an EMI shield, a braided shield, and a jacket, the conductor bundle having three thinner elements.

An improved USB cable is desired.

### SUMMARY OF THE INVENTION

Accordingly, an object of the present invention is to provide a USB cable with low cost for power and signal transmission.

In order to achieve the above-mentioned objects, a USB cable comprises a power wire transferring positive power, a pair of signal wires, a metallic braided layer enclosing on the power wire and the signal wires, an insulative outer jacket surrounding the metallic braided layer, and three drain wires disposed in the metallic braided layer. The power wire comprises a metallic inner conductor and an insulative layer surrounding the inner conductor, and the insulative layer of the power wire is made of Polypropylene. The three drain wires comprises a pair of first drain wires and a second drain wire, and each first drain wire has a larger external dimension than the second drain wire.

Other objects, features and advantages of the invention will be apparent from the following detailed description taken in connection with the accompanying drawings.

### BRIEF DESCRIPTION OF THE DRAWINGS

FIG. 1 is a cross-section view of a USB cable in accordance with the present invention.

### DETAILED DESCRIPTION OF PREFERRED EMBODIMENTS

Reference will now be made to the drawing figures to describe the present invention in detail.

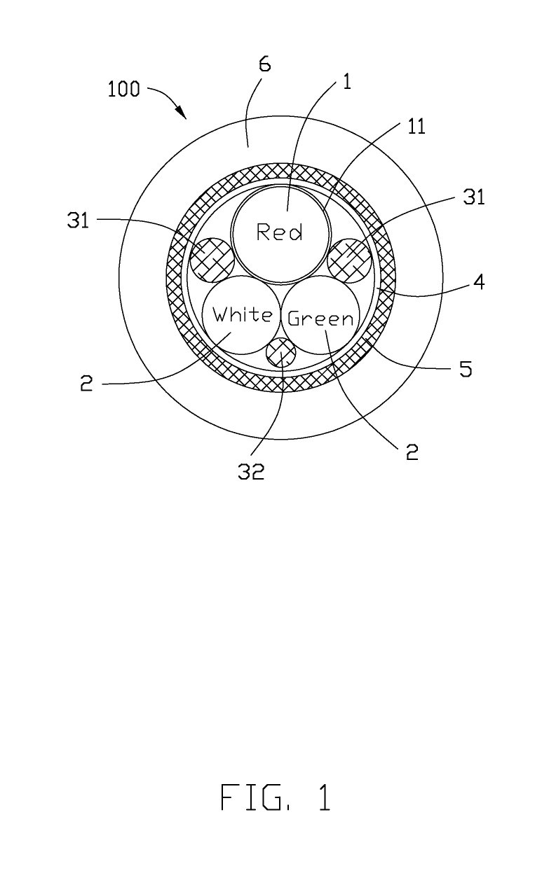

Referring to FIG. 1, a cable 100 in accordance with the present invention is a USB (universal serial bus) cable, and comprises a power wire 1 transmitting positive electricity and a pair of signal wires 2 for differential signal transmission. The power wire 1 and the signal wires 2 are extending along an axial direction of the cable 100, and formed a triangle shape in cross section of the cable 100 roughly.

The power wire 1 is used for transferring +5 v power, the power wire 1 comprises a metallic inner conductor and an insulative layer surrounding the inner conductor, and each signal wire 2 has the same configuration as the power wire 1. The inner conductor is made of copper, and also can be made of aluminum or other selectiveable material. In preferred embodiment, the insulative layer of each signal wire 2 is made of FEP (Fluorinated Ethylene Propylene), and each signal wire 2 has an external dimension increased to 0.62 millimeter, for increasing higher impedance mean value to 90 Ohm. The insulative layer of the power wire 1 is made of PP (Polypropylene) for cost reduction, the power wire 1 has an external dimension increased to 0.78 millimeter. The power wire 1 has an external diameter of 25 AWG (American Wire Gauge), and each signal wire 2 has an external diameter of 31 AWG, thus the power wire 1 has a larger dimension than the signal wire 2. A mylar film 11 is enclosing on the power wire 1 to prevent the USB cable being scratched in manufacturing and using. The insulative layer of the power wire 1 can be defined with thinner dimension but without risk of being scratched, thus it's safe in using and the whole dimension of the cable 100 can be decreased.

The cable 100 also comprises a plurality of drain wires, a mylar layer 4, a metallic braided layer 5 enclosing on the mylar layer 4, and an insulative outer jacket 6 enclosing on the metallic braided layer 5. In preferred embodiment, the cable 100 includes three drain wires which divided into a pair of first drain wires 31 and a second drain wire 32. The first drain wire 31 has a larger external diameter than the second drain wire 32, and the first drain wires 31 are located between the power wire 1 and the neighboring signal wires 2 respectively, the second drain wire 32 is located between the two signal wires 2. Each first drain wire 31 has an external diameter of 29 AWG, and the second drain wire 32 has an external diameter of 31 AWG, thus to match a sectional area of a conventional Vbus wire, and eliminate the need of twisting the metallic braided layer 5 with drain wires during the cable preparation, then reduce the number of handling labors, Specifically, it's expected to save eight operators on each production line. The pair of first drain wires 31 and the second drain wire 32 are arranged in a triangle shape along a cross section view, the three drain wires 31, 32 are in parallel to replace a thick power wire of a conventional USB cable, therefore the number of internal wires of the USB cable can be decreased and the dimension of the whole USB cable is decreased simultaneously.

The mylar layer 4 is enclosing on the power wire 1, the signal wires 2 and the drain wires, and coaxial with the metallic braided layer 5. The metallic braided layer 5 can be of a single layer structure, and also can be of a double layer structure. The external dimension of the cable 100 can be decreased to 2.63 millimeter, and the characteristic impedance of the cable 100 ban be kept on 90 ohm.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A USB cable, comprising:
a power wire transferring positive power, and comprising a metallic inner conductor and an insulative layer surrounding the inner conductor, and the insulative layer of the power wire being made of Polypropylene;
a pair of signal wires;
a metallic braided layer enclosing on the power wire and the signal wires;
an insulative outer jacket surrounding the metallic braided layer; and
three drain wires disposed in the metallic braided layer, and comprising a pair of first drain wires and a second drain wire, each first drain wire having a larger external dimension than the second drain wire.

2. The USB cable as recited in claim 1, wherein each first drain wire has an external diameter of 29 AWG, and the second drain wire has an external diameter of 31 AWG.

3. The USB cable as recited in claim 1, wherein the first drain wires are located between the power wire and the neighboring signal wires respectively, and the second drain wire is located between the two signal wires.

4. The USB cable as recited in claim 3, wherein the pair of first drain wires and the second drain wire are arranged in a triangle shape along a cross section view.

5. The USB cable as recited in claim 3, wherein the power wire and the signal wires are extending along an axial direction of the USB cable, and formed a triangle shape in cross section of the USB cable.

6. The USB cable as recited in claim 5, wherein the power wire has a larger dimension than the signal wire.

7. The USB cable as recited in claim 6, wherein the power wire is transmitting +5V positive electricity and the pair of signal wires is used for differential signal transmission.

8. The USB cable as recited in claim 6, wherein the power wire has an external diameter of 25 AWG, and each signal wire has an external diameter of 31 AWG.

9. The USB cable as recited in claim 3, wherein the external dimension of the USB cable can be decreased to 2.63 millimeter.

10. The USB cable as recited in claim 1, wherein a mylar film is enclosing on the power wire.

11. The USB cable as recited in claim 1, wherein a mylar layer is arranged on the power wire and the signal wires, and enclosed by the metallic braided layer.

12. The USB cable as recited in claim 1, wherein the power wire has an external dimension of 0.78 millimeter.

13. The USB cable as recited in claim 12, wherein each signal wire has an external dimension increased to 0.62 millimeter, and an insulative layer of each signal wire is made of Fluorinated Ethylene Propylene.

14. A USB cable comprising:
at least one power wire transferring positive power, and comprising a metallic inner conductor and an insulative layer surrounding the inner conductor, and the insulative layer of the power wire being made of a thin strong polyester film;
at least one pair of signal wires each equipped with an insulative layer;
a metallic braided layer enclosing on the power wire and the signal wires;
an insulative outer jacket surrounding the metallic braided layer; and
a plurality of drain wires mixed up with the power and signal wires within the metallic braided layer; wherein
the drain wire directly neighboring the power wire is diametrically dimensioned larger than that spaced from the power wire.

15. The USB cable as claimed in claim 14, wherein said drain wire directly neighboring the power wire is to intimately contact the neighboring power wire.

16. The USB cable as claimed in claim 15, wherein the power wire is diametrically larger than each of the signal wires.

17. The USB cable as claimed in claim 16, wherein there are one power wire and one pair of signal wires arranged with an isosceles triangle in a cross-section view, and there are three drain wires arranged with another isosceles triangle inverse to said isosceles triangle and intermingled with the power wire and said pair of signal wires in the cross-sectional view, and two of said drain wires intimately located by two sides of the power wire are diametrically larger than the rest one of the drain wires.
